(19) United States
(12) Patent Application Publication
(10) Pub. No.: US 2019/0058663 A1
(43) Pub. Date: Feb. 21, 2019

(54) Flowlet-Based Load Balancing

(71) Applicant: Futurewei Technologies, Inc., Plano, TX (US)

(72) Inventor: Haoyu Song, San Jose, CA (US)

(21) Appl. No.: 15/850,013

(22) Filed: Dec. 21, 2017

Related U.S. Application Data
(60) Provisional application No. 62/547,396, filed on Aug. 18, 2017.

(51) Int. Cl. H04L 12/803; H04L 12/801; H04L 12/825; H04L 12/851

(52) U.S. Cl. CPC H04L 47/125; H04L 47/18; H04L 47/27; H04L 47/2441; H04L 47/26

(57) ABSTRACT

A network device configured to set a flowlet boundary. The network device includes a receiver, a processor, and a transmitter. The receiver is configured to receive a return acknowledgement (ACK) for each packet from a flow, the processor is configured to start a timer and to manipulate a receiver window (RWND) in the return ACK to generate a false ACK, and the transmitter is configured to transmit the false ACK to a sender host.

### CROSS-REFERENCE TO RELATED APPLICATIONS

This patent application claims the benefit of U.S. Provisional Patent Application No. 62/547,396, filed Aug. 18, 2017, by Haoyu Song and titled “Flowlet-Based Load Balancing,” the teachings and disclosure of which are hereby incorporated in its entirety by reference thereto.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Load balancing refers to the process of distributing packets received at an input port across several output ports in attempt to balance the number of packets output from each port. Load balancing may prevent congestion on certain paths through the network by distributing packets to other less used paths.

In equal cost multiple path (ECMP) load balancing, a fixed path is chosen for a flow based on the hashing of one or more header fields. Due to the flow size distribution and the hash distribution, ECMP may lead to an undesirable load imbalance. In packet-based load balancing, a perfectly balanced load may be achieved on network paths. However, due to the latency variance of different paths, packets may be delivered out of order. As such, the packets need to be re-ordered and the transmission control protocol (TCP) throughput is reduced.

A flowlet is a burst of packets from a flow followed by an idle gap. The idle gap signifies a boundary between different flowlets. Flowlets provide a better granularity for load balancing. As such, flowlet-based load balancing may be superior to ECMP and packet-based load balancing in many circumstances.

### SUMMARY

In an embodiment, the disclosure includes a network device configured to set a flowlet boundary. The network device includes a receiver configured to receive a return acknowledgement (ACK) for each packet from a flow, a processor coupled to the receiver, the processor configured to start a timer and to manipulate a receiver window (RWND) in the return ACK to generate a false ACK, and a transmitter coupled to the processor, the transmitter configured to transmit the false ACK to a sender host.

Optionally, in any of the preceding aspects, another implementation of the aspect provides that a value in the RWND in the false ACK is cleared when the timer has not expired and when not all packets from the flow have been received. Optionally, in any of the preceding aspects, another implementation of the aspect provides that the false ACK is used to instruct the sender host to stop sending packets. Optionally, in any of the preceding aspects, another implementation of the aspect provides that a value in the RWND in the false ACK is set to a value of the RWND from a last-received return ACK when the timer has expired. Optionally, in any of the preceding aspects, another implementation of the aspect provides that the false ACK is used to instruct the sender host to resume sending packets and thereby set the flowlet boundary. Optionally, in any of the preceding aspects, another implementation of the aspect provides that the processor is configured to retrieve the RWND from the last-received return ACK from a flow table. Optionally, in any of the preceding aspects, another implementation of the aspect provides that the transmitter is configured to transmit the last-received return ACK to the sender host when the timer has not expired and when all of the packets from the flow have been received. Optionally, in any of the preceding aspects, another implementation of the aspect provides that the network device comprises a sender-side edge switch. Optionally, in any of the preceding aspects, another implementation of the aspect provides that the receiver is configured to receive the return ACK from a receiver-side edge switch coupled to a receiver host, and wherein the sender-side edge switch and the receiver-side edge switch are disposed on opposing sides of a network. Optionally, in any of the preceding aspects, another implementation of the aspect provides that the network device includes a memory containing a flowlet table, and wherein the processor is configured to store one or more of a last ACK, a last sequence number, and a last RWND.

In an embodiment, the disclosure includes a method of setting a flowlet boundary. The method includes setting a timer, determining that the timer has not expired, capturing a return acknowledgement (ACK) for each packet from a flow, clearing a value in a receiver window (RWND) to generate a false ACK when not all of the packets from the flow have been received to instruct a sender host to stop sending packets, setting a value in the RWND of the false ACK to a value of the RWND from a last-received return ACK when all of the packets have been received, and transmitting the false ACK to the sender host to establish the flowlet boundary.

Optionally, in any of the preceding aspects, another implementation of the aspect provides that determining whether all of the packets from the flow have been received is performed by comparing a value of a sequence field to a value of an acknowledge field. Optionally, in any of the preceding aspects, another implementation of the aspect provides that the timer is a target flowlet gap. Optionally, in any of the preceding aspects, another implementation of the aspect provides that the method is implemented by a sender-side edge switch. Optionally, in any of the preceding aspects, another implementation of the aspect provides storing one or more of a last ACK, a last sequence number, and a last RWND in a flowlet table.

In an embodiment, the disclosure includes a method of setting a flowlet boundary including setting a timer, determining that the timer has expired, generating a false acknowledgement (ACK) by setting a value in a receiver window (RWND) to a value of the RWND from a last-received return ACK, and transmitting the false ACK to a sender host to establish the flowlet boundary.

Optionally, in any of the preceding aspects, another implementation of the aspect provides that the timer is a target flowlet gap. Optionally, in any of the preceding aspects, another implementation of the aspect provides that the method is implemented by a sender-side edge switch.

In an embodiment, the disclosure includes a method of load balancing including determining a size of a current flowlet, comparing the size of the current flowlet to a size of a previous flowlet, transmitting the current flowlet on a same path used to transmit the previous flowlet when the size of the current flowlet has increased relative to the previous flowlet, and transmitting the current flowlet on a randomly selected path when the size of the current flowlet has decreased relative to the previous flowlet.

Optionally, in any of the preceding aspects, another implementation of the aspect provides that the method is implemented by a sender-side edge switch.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a communication system capable of implementing the flowlet-based load balancing technique.

FIG. 2 illustrates a packet that may be transmitted from the sender host to the sender-side edge switch.

FIG. 3 illustrates a return acknowledgement (ACK) that may be received from the receiver host by sender-side edge switch.

FIG. 4 illustrates a flow table utilized by the sender-side edge switch to store the values obtained from the sequence number field, the acknowledgement number field, and the window size field of FIGS. 2-3.

FIG. 5 is a flowchart used to generate the flowlet boundary to perform load balancing.

FIG. 6 is a schematic diagram of a network device.

FIG. 7 is a flowchart illustrating an embodiment of a method of setting a flowlet boundary.

FIG. 8 is a flowchart illustrating an embodiment of a method of setting a flowlet boundary.

FIG. 9 is a flowchart illustrating an embodiment of a method of load balancing.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It is difficult to select the optimal inter-packet idle gap to signify the end of one flowlet and the start of another. If the gap is set too small, there is a high probability that packets will need to be reordered. If the gap is set too large, achieving correct flowlets is difficult and the beneficial load balancing effect deteriorates. This is especially true in, for example, a data center where the path latency may be small (e.g., microseconds) but the latency variance may be relatively large (e.g., milliseconds (ms)).

Disclosed herein is a method of flowlet-based load balancing. Instead of waiting for a path switch opportunity to be decided by native flowlets, a network device (e.g., an edge switch, a network interface controller, a top of rack (ToR) switch) tricks the packet source into producing artificial flowlets any time the network device wants to switch a flow path for load balancing. In an embodiment, the network device achieves this deception by clearing a receiver window (RWND) (e.g., setting the RWND to zero) in a return acknowledgement (ACK) associated with the flow. By doing so, the flow of packets is effectively temporarily halted.

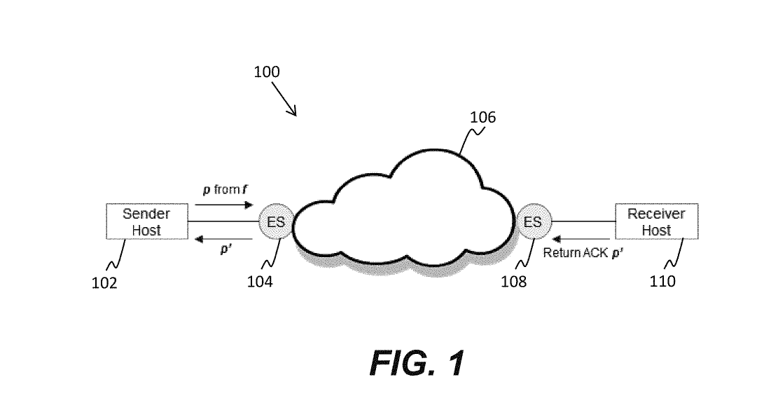

FIG. 1 is a schematic diagram of a communication system 100 capable of implementing the flowlet-based load balancing technique. The communication system 100 comprises a sender host 102, a sender-side edge switch (ES) 104, a network 106, a receiver-side edge switch (ES) 108, and a receiver host 110. The sender host 102, sender-side edge switch 104, network 106, receiver-side edge switch 108, and receiver host 110 are coupled in a manner suitable for the exchange of packets (e.g., data packets). Although not shown, it should be understood that the communication system 100 may include other components or devices in practical applications.

The sender-side edge switch 104 is configured to monitor the bi-directional flow of packets. In an embodiment, the sender-side edge switch 104 is an edge router, a ToR switch, a network interface controller (NIC), a virtual switch or router in a server hypervisor.

The sender-side edge switch 104 is configured to receive a flowlet (f) of packets (p) from the sender host 102 and then transmit that flowlet of packets through the network 106 to the receiver-side edge switch 108. The receiver-side edge switch 108 sends the flowlet of packets on to the receiver host 110. To acknowledge receipt of the packet (or packets), the receiver host 110 transmits the return ACK (p′) for the packet back through the communication system 100 toward the sender host 102. When the return ACK is received by the sender host 102, the sender host 102 is informed that the packet has been received.

During the packet routing process described above, the sender-side edge switch 104 monitors the time between consecutive packets in an attempt to detect the end of one flowlet and the start of another, which is referred to herein as the flowlet boundary (e.g., the inter-packet idle gap between different flowlets). Upon detecting a flowlet boundary, the sender-side edge switch 104 changes the output port being used to transmit the packets. By changing the output port, a less congested path through the network may be utilized. The more often this type of path switching occurs, the better the load balancing effect, which leads to improved throughput.

The flowlet boundary is typically set to a certain amount of time (e.g., 10 ms) by, for example, a network administrator managing the sender-side edge switch. If the flowlet boundary is set too small, packets from the same flowlet may be transmitted on different paths and arrive at the receiver host out of order. As such, the packets have to be re-ordered, which lowers the throughput of the system. If the gap is set too large, the different flowlets are not properly detected. As such, different paths are not used for different flowlets and the beneficial load balancing effect deteriorates. Therefore, setting the flowlet boundary to an optimal value in order to accurately detect the flowlet boundary is desired. Unfortunately, correctly setting the flowlet boundary is difficult. As will be more fully explained below, the present disclosure provides a technique to optimally set the flowlet boundary to achieve better load balancing.

Still referring to FIG. 1, the sender-side edge switch 104 receives the return ACK transmitted by the receiver host 110. However, instead of simply transmitting the return ACK to the sender host 102, the sender-side edge switch 104 clears the RWND to indicate that the receiver host 110 is unable to receive any data at the present time. Thereafter, the sender-side edge switch 104 transmits the modified return ACK to the sender host 102. The sender host 102 compares the RWND in the return ACK to a congestion window (CWND) and uses the smaller value to determine how much data can be sent. Because the RWND has been set to zero, the sender host 102 will determine that no additional data can be sent at the present time. Thus, the sender host 102 temporarily stops sending packets, which artificially creates a flowlet boundary.

In order to restart the flow of packets from the sender host 102, the sender-side edge switch 104 monitors a timer and awaits receipt of a return ACK corresponding to the last packet in the previously sent flowlet. If the timer expires before the return ACK corresponding to the last packet is received, the sender-side edge switch 104 generates a false return ACK containing the last known RWND and sends the false return ACK to the sender host 102. If the return ACK corresponding to the last packet is received prior to expiration of the time, the sender-side edge switch 104 forwards the return ACK corresponding to the last packet, which should contain an RWND having a value other than zero, to the sender host 102. In either case, the sender host 102 compares the RWND to the CWND and uses the smaller value to determine how much data can be sent. Thereafter, the sender host 102 is able to begin sending packets and a new flowlet may be transmitted.

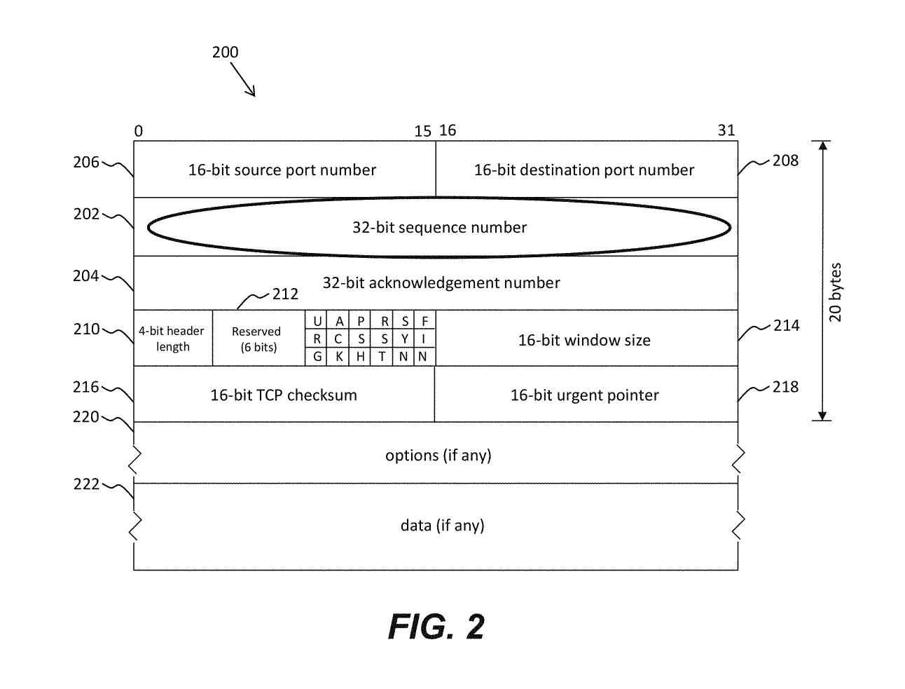

FIG. 2 illustrates a packet 200 that may be transmitted from the sender host 102 to the sender-side edge switch 104 of FIG. 1. As shown, the packet 200 contains a sequence number field 202. In an embodiment, the sequence number field 202 is 32-bits. The sequence number field 202 includes a value referred to as the sequence number. The sequence number is the byte offset of the first data of this packet 200 from the first sequence number of the first packet in a flow. That is, it is the byte index of the first data in this packet 200. An acknowledgement number field 204 includes a value referred to as the acknowledgement number. The acknowledgement number is the index of the next expected data from the receiver, which means all data before this index has been correctly received. For example, the sender sends a packet with the sequence number 1000 and the packet data length is 100. If this packet (as well as all other packets before this packet) is correctly received, the returning ACK packets should include an acknowledgement number of 1100 (it means all data byte before index 1100 has been received and the sender can start to send next packet with the sequence number of 1100) indicating the number of bytes of data transmitted by the sender host.

In addition to the sequence number field 202 and the acknowledgement number field 204, the packet 200 contains a source port number field 206, a destination port number field 208, a header length field 210, a reserved bits field 212, a window size field 214, a TCP checksum field 216, an urgent pointer field 218, an options field 220, and a data field 222. The source port number field 206 may contain a value representing a source port. In an embodiment, the source port number field 206 is 16-bits. The destination port number field 208 may contain a value representing the destination port. In an embodiment, the destination port number field 208 is 16-bits. The header length field 210 may contain a value representing a length of the header. In an embodiment, header length field 210 is 4-bits.

The reserved bits field 212 may be a field reserved for later use. In an embodiment, the reserved bits field 212 is 16-bits. The window size field 214 may contain a value representing a window size. In an embodiment, the window size field 214 is 16-bits. The TCP checksum field 216 may contain a value representing the TCP checksum. In an embodiment, the TCP checksum field 216 is 16-bits. The urgent pointer field 218 may contain a value representing the urgent pointer. In an embodiment, the urgent pointer field 218 is 16-bits. The options field 220 may contain optional values or information, if any. In an embodiment, the options field 220 is 32-bits. The data field 222 may contain data (e.g., the payload) of the packet 200, if any. In an embodiment, the data field 222 is 32-bits. Despite the illustrated embodiment, the packet 200 may contain other or additional fields in practical applications.

As shown in FIG. 2, the sequence number field 202, the acknowledgement number field 204, the source port number field 206, the destination port number field 208, the header length field 210, the reserved bits field 212, the window size field 214, the TCP checksum field 216, and the urgent pointer field 218 may be collectively 20 bytes.

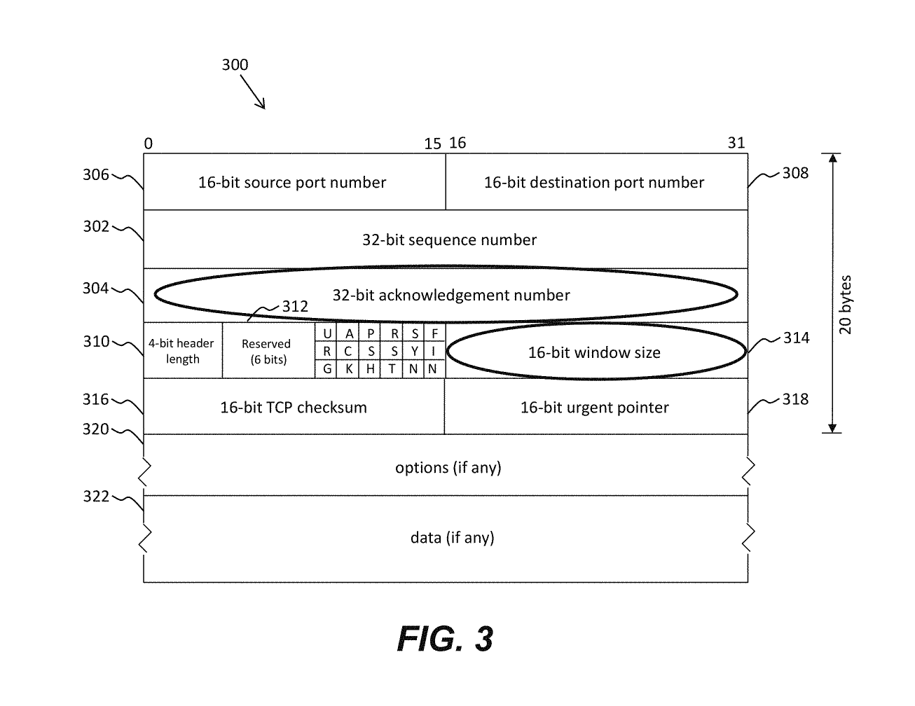

FIG. 3 illustrates a return ACK 300 that may be received from the receiver host 110 by sender-side edge switch 104 of FIG. 1. As shown, the return ACK 300 contains a sequence number field 302, an acknowledgement number field 304, and a window size field 314. The sequence number field 302 includes a value referred to as the sequence number. The acknowledgement number field 304 includes a value referred to as the acknowledgement number. In an embodiment, the sequence number field 302 and/or the acknowledgement number field 304 is 32-bits. The window size field 314 may contain a value indicating the window size. In an embodiment, the window size field, which is the RWND field, is 16-bits.

Note that a TCP flow may be a bi-directional flow, which means both sides can act as a sender. As such, TCP packets (e.g., packet 200 and return ACK 300) include the sequence number and the acknowledgement number in both directions. The sequence number field 302 in the return ACK 300 is actually for the “receiver” to track the data it sends to the “sender.” To simplify the description, one side is assumed to be the sender and the other side as the receiver so we can ignore the sequence number field 302 in the return ACK 300.

In addition to the sequence number field 302, the acknowledgement number field 304, and the window size field 314, the return ACK 300 (which is also a packet) may contain a source port number field 306, a destination port number field 308, a header length field 310, a reserved bits field 312, a window size field 314, a TCP checksum field 316, an urgent pointer field 318, an options field 320, and a data field 322. The source port number field 306 may contain a value representing a source port. In an embodiment, the source port number field 306 is 16-bits. The destination port number field 308 may contain a value representing the destination port. In an embodiment, the destination port number field 308 is 16-bits. The header length field 310 may contain a value representing a length of the header. In an embodiment, the header length field 310 is 4-bits.

The reserved bits field 312 may be a field reserved for later use. In an embodiment, the reserved bits field 312 is 16-bits. The window size field 314 may contain a value representing a window size. In an embodiment, the window size field 314 is 16-bits. The TCP checksum field 316 may contain a value representing the TCP checksum. In an embodiment, the TCP checksum field 316 is 16-bits. The urgent pointer field 318 may contain a value representing the urgent pointer. In an embodiment, the urgent pointer field 318 is 16-bits. The options field 320 may contain optional values or information, if any. In an embodiment, the options field 320 is 32-bits. The data field 322 may contain data (e.g., the payload) of the return ACK 300, if any. In an embodiment, the data field 322 is 32-bits. Despite the illustrated embodiment, the return ACK 300 may contain other or additional fields in practical applications.

As shown in FIG. 3, the sequence number field 302, the acknowledgement number field 304, the source port number field 306, the destination port number field 308, the header length field 310, the reserved bits field 312, the window size field 314, the TCP checksum field 316, and the urgent pointer field 318 may be collectively 20 bytes.

As will be more fully explained below, FIGS. 2-3 highlight the fields that are tracked in the flow table in the sender-side edge switch 104. FIG. 2 represents the data packet 200 from the sender host 102 and FIG. 3 represents the return ACK 300 (a.k.a., return ACK packet) from the receiver host 110.

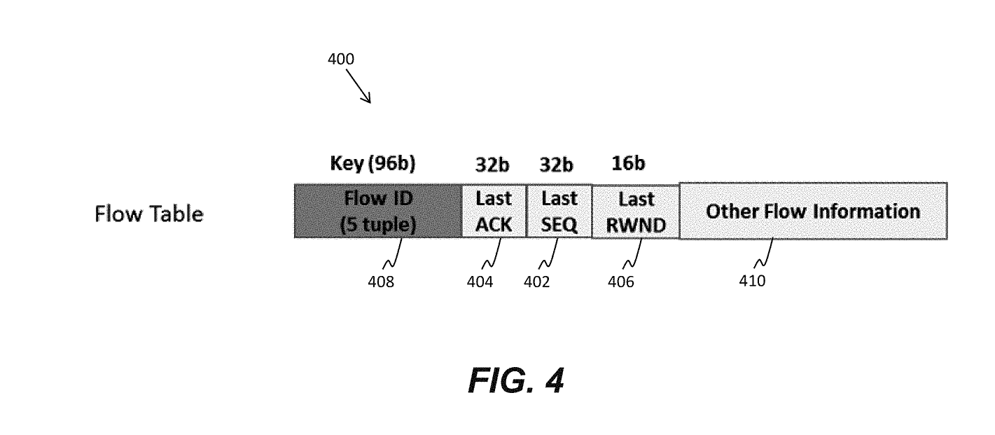

FIG. 4 illustrates a flow table 400 utilized by the sender-side edge switch 104 of FIG. 1 to store the values obtained from the sequence number field 202, 302, the acknowledgement number field 204, 304, and the window size field 214, 314 of FIGS. 2-3. For example, the values obtained from the sequence number field 202, 302 may be stored in a last sequence (SEQ) field 402, the values obtained from the acknowledgement number field 204, 304 may be stored in a last ACK field 404, and the values obtained from the window size field 214, 314 may be stored in a last RWND field 406.

In addition to the sequence number field 202, 302, the acknowledgement number field 204, 304, and the window size field 214, 314, the flow table 400 may include other information such as the flow identification (ID) in the flow ID field 408 and other flow information in the other flow information field 410.

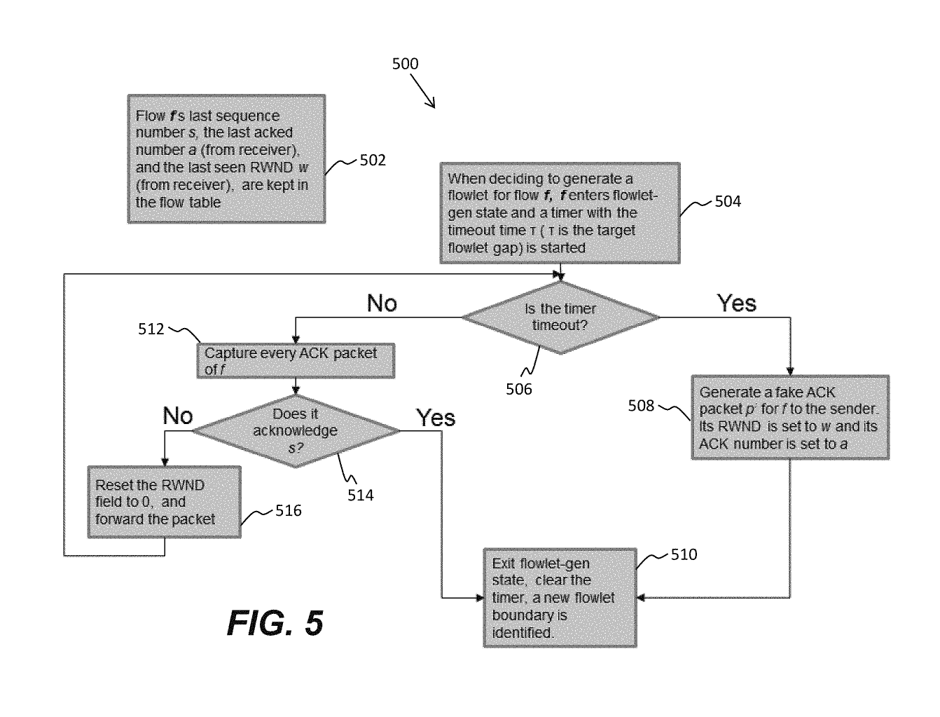

FIG. 5 is a flowchart 500 (e.g., state machine) used to generate the flowlet boundary (e.g., idle gap between consecutive packets of different flows) to perform load balancing as discussed herein. In an embodiment, the load balancing is achieved by implementing an algorithm that performs one or more of functions described herein. As shown in block 502, the sender-side edge switch 104 of FIG. 1 has stored the last sequence number (s), the last ACK number (a) from the receiver host 110 of FIG. 1, and the most recent RWND (w) from the receiver host 110 of FIG. 1 in the flow table 400 of FIG. 4. In an embodiment, the sender-side edge switch 104 of FIG. 1 stores such information for each flowlet. In an embodiment, a plurality of different flowlets is received by the sender-side edge switch 104 of FIG. 1 simultaneously. However, for the purpose of discussion a single flowlet (f) will be discussed.

In block 504, the sender-side edge switch 104 initiates a flowlet-generation state for the flowlet and starts a timer with a timeout time (T) representing the desired flowlet boundary. In decision block 506, a determination is made as to whether the timer has timed out. If the timer has timed out, the YES branch is followed. In block 508, the sender-side edge switch 104 generates the false ACK (p′) for the packet from flowlet (f) and sends the false ACK to the sender host 102 as shown in FIG. 1. In doing so, the sender-side edge switch 104 sets the last sequence number in the false ACK (e.g., the RWND) to the most recent RWND from the receiver host (w) and sets the ACK number to the last ACK number from the receiver host (a). In an embodiment, the most resent RWND from the receiver host and the last ACK number from the receiver host are stored in the flow table 400 of FIG. 4.

After the false ACK has been sent to the sender host 102, the flowchart 500 proceeds to block 510. In block 510, the flowlet boundary generation state is exited. As part of that, the timer is cleared and a new flowlet boundary is identified. In an embodiment, the process may be repeated after a flow of packets corresponding to the new flowlet boundary has been sent. That is, the process may be performed again to generate the next new flowlet boundary to achieve desirable load balancing.

Referring back to block 506, if the timer has not timed out, the NO branch is followed. In block 512, every ACK corresponding to the packets in the flow is captured by the sender-side edge switch 104 of FIG. 1. In an embodiment, the information from the captured ACKs (e.g., the acknowledgement and the RWND) is stored in the flow table 400 of FIG. 4. In decision block 514, the acknowledgement number (a) for each packet is compared to the sequence number (s) stored in the flow table. If the acknowledgement number is greater than the sequence number, then all packets have been received. In that case, the ACK of the last-received packet is sent to the sender host 102 to resume the transmission of packets and the YES branch is followed to block 510 where the flowlet boundary generation state is exited. As part of that, the timer is cleared and a new flowlet boundary is identified. In an embodiment, the process may be repeated after a flow of packets corresponding to the new flowlet boundary has been sent. That is, the process may be performed again to generate the next new flowlet boundary to achieve desirable load balancing.

If the acknowledgement number is less than or equal to the sequence number, then there are still packets that have not been received. In that case, the NO branch is followed. In block 516, the RWND field is reset to zero and the ACK for the packet is forwarded to the sender. Thereafter, the process goes back to decision block 506 and continues accordingly.

In addition to the above, disclosed herein is a process of load balancing based on the trend of the flowlet size. If the flowlet size in increasing, the flowlet is forwarded using the current output port and path (e.g., no path switching). If the flowlet size is decreasing, the flowlet is forwarded using a randomly selected output port and path.

By way of background, Cisco Systems, Inc. (Cisco) introduced a LetFlow algorithm in a document by Vanini, et al., entitled “Let it Flow: Resilient Asymmetric Load Balancing with Flowlet Switching,” Mar. 27-29, 2017, which is incorporated herein by reference. LetFlow shows similar flow completion time (FCT) performance as the more complex scheme known as CONGA, which is a network-based distributed congestion-aware load balancing mechanism for datacenters. LetFlow is basically the original load balancing scheme where, at a switch with multiple alternative paths for a flow, a path is randomly selected for each flowlet to forward. Flowlets have a natural tendency to shift from slow (congested) paths towards fast (uncongested) paths. Analysis and experiments have confirmed this tendency. Cisco implemented LetFlow in some of their switches.

Unfortunately, the convergence time to the ideal equilibrium can be long, which negatively affects the FCT performance. This is especially true for small flows. Because the path latency on asymmetric networks may differ substantially, the frequent flowlet switch may incur excessive packet reordering. This also affects the FCT performance. Thus, it is desirable to mitigate the above-noted drawbacks and provide new optimizations to improve performance of a flowlet switch.

Based on insight similar to that used with LetFlow, an improved flowlet load balancing scheme is provided. As noted above, the process of load balancing is based on the trend of the flowlet size. If the flowlet size is increasing, the flowlet is forwarded using the current output port and path (e.g., no path switching). When the flowlet size is increasing, it is an indicator that the current path bandwidth for the flow is not saturated and the flow is increasing its throughput. As such, it is preferable to maintain the same forwarding path. If the flowlet size is decreasing, the flowlet is forwarded using a randomly selected output port and path. As such, the path switch for the flowlet should be enabled for load balancing.

In an embodiment, the following may be used for a flow record data structure:

flow-record {

int output-port;
int timestamp;
int previous-flowlet-size;
int flowlet-counter;

}

In an embodiment, the following may be used as the pseudo code of the algorithm:

for(each new arrival p){

if(p is from a new flow f) {

create a flow entry for f;
randomly pick a port n;
f[p].output-port=n;
f[p].timestamp=p.time;
f[p].previous-flowlet-size=0;
f[p].flowlet-counter=1;

}else if(p.time-f[p].timestamp>=t){

if(f[p].flowlet-counter<f[p].previous-flowlet-size){

randomly pick a port n;
f[p].output-port=n;

}
f[p].previous-flowlet-size=f[p].flowlet-counter;
f[p].flowlet-counter=1;

}else{

f[p].flowlet-counter++;
f[p].timestamp=p.time;

}
Send p to f[p].output-port;

}

The flow record data structure and the pseudo code of the algorithm may be used to perform load balancing based on the trend of the flowlet size. In such load balancing, the dynamic trend of the flowlet size is used as an indicator. This is in contrast to conventional load balancing schemes that either chose paths in a round robin fashion or randomly, or chose the path based on the active path congestion measurement (e.g., COGNA).

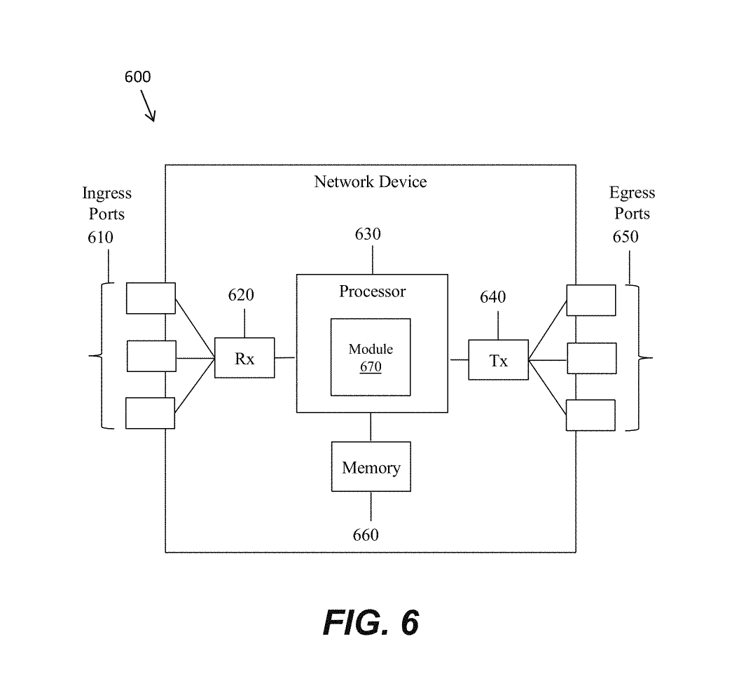

FIG. 6 is a schematic diagram of a network device 600 according to an embodiment of the disclosure. The network device 600 is suitable for implementing the disclosed embodiments as described herein. The network device 600 comprises ingress ports 610 and receiver units (Rx) 620 for receiving data; a processor, logic unit, or central processing unit (CPU) 630 to process the data; transmitter units (Tx) 640 and egress ports 650 for transmitting the data; and a memory 660 for storing the data. The network device 600 may also comprise optical-to-electrical (OE) components and electrical-to-optical (EO) components coupled to the ingress ports 610, the receiver units 620, the transmitter units 640, and the egress ports 650 for egress or ingress of optical or electrical signals.

The processor 630 is implemented by hardware and software. The processor 630 may be implemented as one or more CPU chips, cores (e.g., as a multi-core processor), field-programmable gate arrays (FPGAs), application specific integrated circuits (ASICs), and digital signal processors (DSPs). The processor 630 is in communication with the ingress ports 610, receiver units 620, transmitter units 640, egress ports 650, and memory 660. The processor 630 comprises a load balancing module 670. The load balancing module 670 implements the disclosed embodiments described above. For instance, the load balancing module 670 implements, processes, prepares, or provides the various functions of the sender-side edge switch. The inclusion of the load balancing module 670 therefore provides a substantial improvement to the functionality of the network device 600 and effects a transformation of the network device 600 to a different state. Alternatively, the load balancing module 670 is implemented as instructions stored in the memory 660 and executed by the processor 630.

The memory 660 comprises one or more disks, tape drives, and solid-state drives and may be used as an over-flow data storage device, to store programs when such programs are selected for execution, and to store instructions and data that are read during program execution. The memory 660 may be volatile and/or non-volatile and may be read-only memory (ROM), random access memory (RAM), ternary content-addressable memory (TCAM), and/or static random-access memory (SRAM).

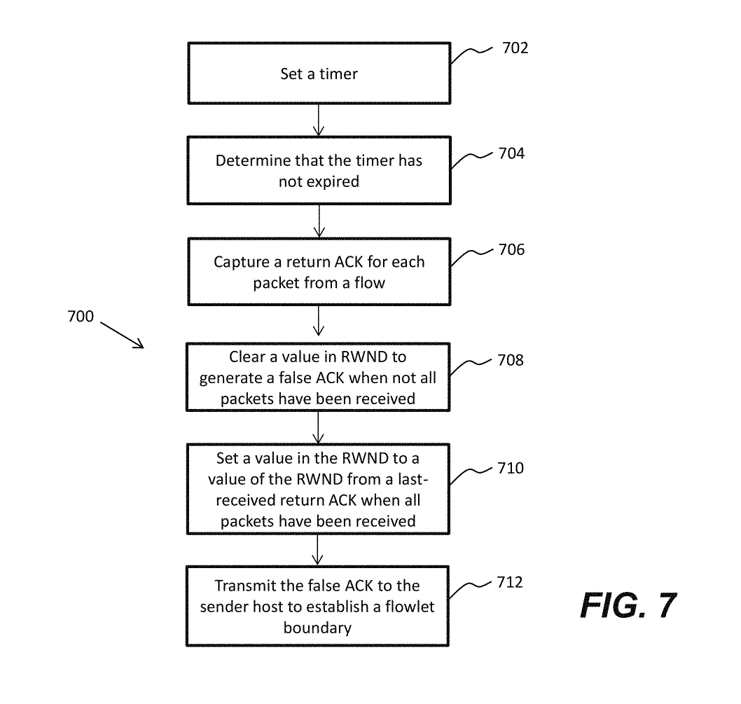

FIG. 7 illustrates a method 700 of setting a flowlet boundary in one embodiment. In block 702, a timer is set. In an embodiment, the setting of the timer corresponds to block 504 in FIG. 5. In block 704, a determination that the timer has not expired is made. In an embodiment, the determination that the timer has not expired corresponds to block 506 in FIG. 5. In block 706, the return ACK for each packet from a flow is captured. In an embodiment, the capture of each packet corresponds to block 512 of FIG. 5.

In block 708, a value in the RWND is cleared to generate a false ACK when not all of the packets from the flow have been received. In an embodiment, the clearing corresponds to block 516 in FIG. 5. The RWND is cleared to instruct a sender host (e.g., sender host 102 of FIG. 1) to stop sending packets. In block 710, a value in the RWND of the false ACK is set to a value of the RWND from a last-received return ACK when all of the packets have been received. In block 712, the false ACK is transmitted to the sender host to establish the flowlet boundary.

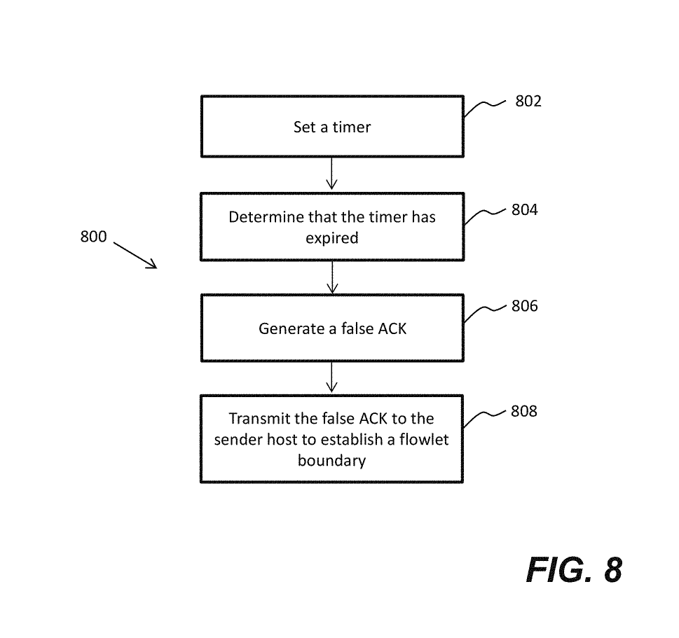

FIG. 8 illustrates a method 800 of setting a flowlet boundary in one embodiment. In block 802, a timer is set. In an embodiment, the setting of the timer corresponds to block 504 in FIG. 5. In block 804, a determination that the timer has expired is made. In an embodiment, the determination that the timer has not expired corresponds to block 506 in FIG. 5. In block 806, a false ACK is generated by setting a value in the RWND to a value of the RWND from a last-received return ACK. In block 808, the false ACK is transmitted to a sender host to establish the flowlet boundary.

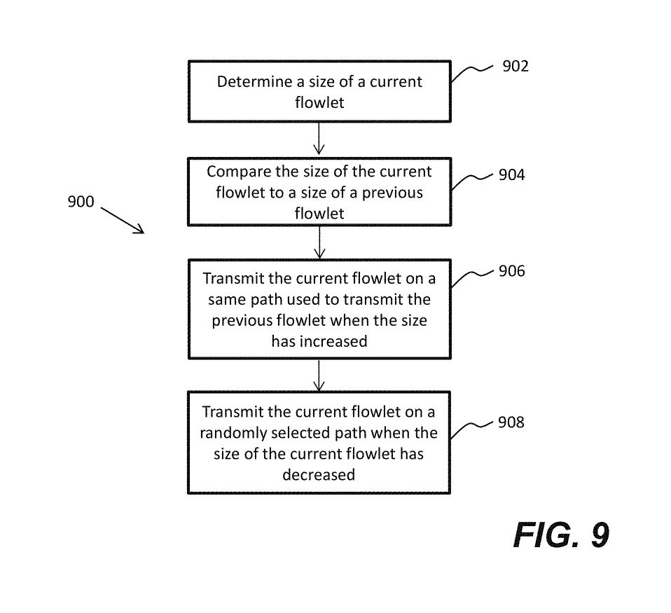

FIG. 9 illustrates a method 900 of load balancing in one embodiment. In block 902, a size of a current flowlet is determined. In block 904, the size of the current flowlet is compared to a size of a previous flowlet. In block 906, the current flowlet is transmitted on a same path used to transmit the previous flowlet when the size of the current flowlet has increased relative to the previous flowlet. In block 908, the current flowlet is transmitted on a randomly selected path when the size of the current flowlet has decreased relative to the previous flowlet.

In an embodiment, the disclosure includes a network device configured to set a flowlet boundary. The network device includes receiving means configured to receive a return acknowledgement (ACK) for each packet from a flow, processing means coupled to the receiving means, the processing means configured to start a timer and to manipulate a receiver window (RWND) in the return ACK to generate a false ACK, and transmitting means coupled to the processing means, the transmitting means configured to transmit the false ACK to a sender host.

In an embodiment, the disclosure includes a method of setting a flowlet boundary. The method includes setting a timer with a setting means, determining that the timer has not expired with a determining means, capturing a return acknowledgement (ACK) for each packet from a flow with a capturing means, clearing a value in a receiver window (RWND) to generate a false ACK when not all of the packets from the flow have been received to instruct a sender host to stop sending packets with a clearing means, setting a value in the RWND of the false ACK to a value of the RWND from a last-received return ACK when all of the packets have been received with a setting means, and transmitting the false ACK to the sender host to establish the flowlet boundary with a transmitting means.

In an embodiment, the disclosure includes a method of setting a flowlet boundary including setting a timer with a setting means, determining that the timer has expired with a determining means, generating a false acknowledgement (ACK) by setting a value in a receiver window (RWND) to a value of the RWND from a last-received return ACK with a setting means, and transmitting the false ACK to a sender host to establish the flowlet boundary with a transmitting means.

In an embodiment, the disclosure includes a method of load balancing including determining a size of a current flowlet with a determining means, comparing the size of the current flowlet to a size of a previous flowlet with a comparing means, transmitting the current flowlet on a same path used to transmit the previous flowlet when the size of the current flowlet has increased relative to the previous flowlet with a transmitting means, and transmitting the current flowlet on a randomly selected path when the size of the current flowlet has decreased relative to the previous flowlet with the transmitting means.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A network device configured to set a flowlet boundary, comprising:
a receiver configured to receive a return acknowledgement (ACK) for each packet from a flow;
a processor coupled to the receiver, the processor configured to start a timer and to manipulate a receiver window (RWND) in the return ACK to generate a false ACK; and
a transmitter coupled to the processor, the transmitter configured to transmit the false ACK to a sender host.

2. The network device of claim 1, wherein a value in the RWND in the false ACK is cleared when the timer has not expired and when not all packets from the flow have been received.

3. The network device of claim 2, wherein the false ACK is used to instruct the sender host to stop sending packets.

4. The network device of claim 1, wherein a value in the RWND in the false ACK is set to a value of the RWND from a last-received return ACK when the timer has expired.

5. The network device of claim 4, wherein the false ACK is used to instruct the sender host to resume sending packets and thereby set the flowlet boundary.

6. The network device of claim 4, wherein the processor is configured to retrieve the RWND from the last-received return ACK from a flow table.

7. The network device of claim 4, wherein the transmitter is configured to transmit the last-received return ACK to the sender host when the timer has not expired and when all of the packets from the flow have been received.

8. The network device of claim 1, wherein the network device comprises a sender-side edge switch.

9. The network device of claim 8, wherein the receiver is configured to receive the return ACK from a receiver-side edge switch coupled to a receiver host, and wherein the sender-side edge switch and the receiver-side edge switch are disposed on opposing sides of a network.

10. The network device of claim 1, wherein the network device includes a memory containing a flowlet table, and wherein the processor is configured to store one or more of a last ACK, a last sequence number, and a last RWND.

11. A method of setting a flowlet boundary, comprising:
setting a timer;
determining that the timer has not expired;
capturing a return acknowledgement (ACK) for each packet from a flow;
clearing a value in a receiver window (RWND) to generate a false ACK when not all of the packets from the flow have been received to instruct a sender host to stop sending packets;
setting a value in the RWND of the false ACK to a value of the RWND from a last-received return ACK when all of the packets have been received; and
transmitting the false ACK to the sender host to establish the flowlet boundary.

12. The method of claim 11, wherein determining whether all of the packets from the flow have been received is performed by comparing a value of a sequence field to a value of an acknowledge field.

13. The method of claim 11, wherein the timer is a target flowlet gap.

14. The method of claim 11, wherein the method is implemented by a sender-side edge switch.

15. The method of claim 11, further comprising storing one or more of a last ACK, a last sequence number, and a last RWND in a flowlet table.

16. A method of setting a flowlet boundary, comprising:
setting a timer;
determining that the timer has expired;
generating a false acknowledgement (ACK) by setting a value in a receiver window (RWND) to a value of the RWND from a last-received return ACK; and
transmitting the false ACK to a sender host to establish the flowlet boundary.

17. The method of claim 16, wherein the timer is a target flowlet gap.

18. The method of claim 16, wherein the method is implemented by a sender-side edge switch.

19. A method of load balancing, comprising:
determining a size of a current flowlet;
comparing the size of the current flowlet to a size of a previous flowlet;
transmitting the current flowlet on a same path used to transmit the previous flowlet when the size of the current flowlet has increased relative to the previous flowlet; and
transmitting the current flowlet on a randomly selected path when the size of the current flowlet has decreased relative to the previous flowlet.

20. The method of claim 19, wherein the method is implemented by a sender-side edge switch.
